(19) United States
(12) Patent Application Publication
(10) Pub. No.: US 2013/0127969 A1
(43) Pub. Date: May 23, 2013

(54) PRINT HEAD ELEMENT, PRINT HEAD AND IONOGRAPHIC PRINTING APPARATUS

(71) Applicants: Lucien De Schamphelaere, Edegem (BE); Bert Vackier, Gravenwezel (BE); Serge Tavernier, Lint (BE); Axel Van Den Bosch, Lint (BE); Lieven De Schamphelaere, Boutersem (BE); Maarten Tavernier, Antwerpen (BE)

(72) Inventors: Lucien De Schamphelaere, Edegem (BE); Bert Vackier, Gravenwezel (BE); Serge Tavernier, Lint (BE); Axel Van Den Bosch, Lint (BE); Lieven De Schamphelaere, Boutersem (BE); Maarten Tavernier, Antwerpen (BE)

(73) Assignee: TRIAKON NV, Edegem (BE)

(21) Appl. No.: 13/814,139

(22) PCT Filed: Aug. 4, 2010
(86) PCT No.: PCT/IB10/53533

§ 371 Date: Feb. 4, 2013

(51) Int. Cl. B41J 2/41

(52) U.S. Cl. CPC B41J 2/41
USPC 347/125; 347/126

(57) ABSTRACT

A print head element part of an ionographic print head is provided having a mechanism for introducing at one end an ionisable gas or gas mixture into a tubular channel, the print head element further having a planar driver electrode and a planar control electrode both surrounding channel, a dielectric body keeping driver electrode and control electrode separate, a source for applying an alternating voltage for the ionization of the gas or gas mixture in channel, a modulation electrode being separated from control electrode by dielectric material, a source for applying a direct current voltage between modulation electrode and control electrode to either block ions in channel or to allow the flow out of ions from channel.

### FIELD OF THE INVENTION

The present invention relates to a print head element, print head and printing apparatus including same for use in ionographic printing.

### BACKGROUND OF THE INVENTION

For many years printing proceeds with letterpress, gravure (intaglio) or planographic (lithographic) printing machines wherein a printing ink receptor, usually paper, makes direct contact with an inked printing form [ref. e.g. Printing Technology by J. Michael Adams et al.—Delmar Publishers Inc. (1988)].

Nowadays other printing processes, so-called non-impact printing processes have found application, e.g. electrostatic printing, and ink jet printing (ref. e.g. “Principles of Non-Impact Printing” by Jerome L. Johnson (1986)—Palatino Press—Irvine Calif., 92715 U.S.A.).

In order for these non-impact printing systems to be competitive with classical “impact” or “contact” printing they have to be adapted for high speed printing at long runs and have to possess the capability of printing on both sides (duplex printing) which is common praxis in printing of books and journals, and have to be suited for large format printing.

Two electrostatic printing systems have gained particular importance.

A first system called electrophotographic printing is based on the use of an electrostatically chargeable photoconductive member that is image wise discharged through image wise photo-exposure whereupon the residual charge pattern is developed with dry toner particles or toner particles dispersed in an insulating liquid.

A second system is based on the use of a non-photosensitive dielectric member, i.e. electrostatically chargeable member, that is charged in image configuration by various means such as electron beams, ionographic print heads, contacting electrode wires, electronic stencils or shaped masks, the development of the obtained electrostatic charge pattern being the same as described for the electrophotographic printing process.

Both said electrostatic printing processes have been described in U.S. Pat. No. 5,740,510 and 5,765,081 in connection with the structure and use of an electrostatographic multicolour printing apparatus for single pass sequential duplex printing on a web-type toner image receptor material.

While photoconductive imaging members require to be shielded against light of the environment, dielectric members used in image wise electrostatic charging have the advantage that they can hold an electrical charge in the presence of visible light which makes them more practical in commercial use and in the design of the housing of the printing machine.

At present in electrostatic ionographic printing, an electrostatic charge pattern on a dielectric member is formed by means of pattern wise ion-deposition from an ionographic print head, wherein two types of print heads may be distinguished.

A first type of ionographic print head operates with a corona wire to produce an air-assisted stream of plasma containing positive ions caused to blow out through a slit formed by a machined surface of a modulation array containing electrode fingers that can deflect said ions and locally eliminate them from the air stream. Such is realized in the commercial ionographic print head known under the “trade name” CORJET. Such device operating with corona discharge for plasma formation and ion generation is described e.g. in U.S. Pat. No. 4,743,925, and published European Patent Application EP 0578882.

A second type of ionographic print head operates with an ion generator including two electrodes, driver and control electrode, separated by a solid insulator (dielectric). When a high frequency electric field (R.F. field) is applied between said electrodes a pool of plasma containing ions and electrons is generated in an ionisable gas that has been injected into a micro chamber comprising a control electrode having a cavity facing a flat modulation electrode also called screen electrode having an aperture for output of an ion beam. Examples of such print heads producing a single type of ions are described e.g. in published European Patent Application 0 541 841 A1, U.S. Pat. Nos. 4,675,703 and 4,697,196.

In U.S. Pat. No. 4,538,163 a fluid jet assisted ion projection and printing apparatus is described wherein substantially equal numbers of positive and negative ions are generated simultaneously during a series of RF arc breakdowns which take place within an elongated fluid transport channel passing through the body of the apparatus (see e.g. FIG. 7 thereof). The rapidly moving fluid, i.e. air steam, passes through said elongated channel being actually a slit, transports the ions which may be allowed to pass out of the body or may be neutralized within the body by ion modulation electrodes. Ions of selected sign are accelerated and deposited image wise upon a relatively moving charge receptor. According to U.S. Pat. No. 4,538,163 (see FIG. 7) said elongated channel (slit) is formed in a dielectric body containing an electrode wire as RF electrode operating in conjunction with a top field electrode for creating the desired ions. Modulation electrodes in the form of conductive stripes follow the wall of said elongated channel. In an improvement the modulation electrodes are protected against RF arc discharge taking place in the channel. Therefore a foil interface electrode, preferably made of platinum, is positioned between the dielectric body and a dielectric interface plate. A disadvantage associated with the use of an ionographic print head operating with an elongated channel for producing and conducting ions instead of a row of tubular channels will be cross-talk in the reproduction of neighbouring image dots. Moreover, it will be difficult to have an even flow through of ionisable gas in an elongated channel when using a single tubular gas introduction conduit as illustrated e.g. in FIGS. 3 to 7.

The use of a wire as RF electrode and upstanding electrode strips in the elongated channel will make it very difficult to produce such print head by planar microelectronic production techniques.

Further, it has to be stated that equal amounts of ions of opposite sign will not be produced with the ionization print head according to U.S. Pat. No. 4,538,163 when as ionisable gases noble gases such as helium and argon are used. Only plasmas containing positive ions and electrons are formed with noble gases by their chemical inactivity in accepting electrons.

The use of said noble gases in ionography operating with print head elements comprising three electrodes, viz. control, driver and modulation electrode, is described in published European Patent Application number 0 541 841 A1. As described therein it has been found that if a substantial portion of the air in the discharge region, i.e. micro chamber of the ionographic print head, is replaced with nitrogen, elemental noble gases, mixtures of noble gases, or mixtures of nitrogen with one or more noble gases, uniformity and/or print head life can be significantly enhanced. As illustrated in FIG. 3 of the last mentioned European Patent Application nitrogen or like gas is introduced under pressure into the discharge region through the insulating spacer that separates a cavitated control electrode and an apertured modulation electrode. The intake of ionisable gas proceeds under pressure diametrically to the output aperture of the modulation electrode which will result in turbulence in the projected ion stream followed later on by toner-development of reduced image sharpness and decrease of image resolution.

An ion print head and image forming apparatus not relying on the use of driver, control and modulation electrodes as in the previous prior art is described in U.S. Pat. No. 5,406,314 (see its FIGS. 1 and 2).

Each discharge cell in said ion print head operates with a needle electrode inside a discharge tunnel (tubular channel) perpendicular in direction to the wall of said tunnel pointing toward an opposite inner wall of said tunnel. A wraparound electrode is present at an output portion of the tunnel that is adjacent to a dielectric layer serving as positive ion receiving layer for forming a latent electrostatic image thereon.

The disadvantage of said ion print head resides in the complex arrangement of a needle electrode in a small ionization tunnel perpendicular to the axis of said tunnel and the presence of said wraparound electrode inside said tunnel which does not allow the production of such discharge cells by planar microelectronic production techniques.

As is known planar microelectronic production techniques make use of coating of dielectric resin layers, photo-hardening of resin layers for forming etching-resistant portions, vapour deposition of metals, sputtering and etching of metals on slices of dielectric material in order to produce planar layered integrated circuits.

### OBJECT OF THE INVENTION

It is the object of the present invention to provide an ionographic print head containing print head elements having a non-complicated structure allowing their simultaneous production in large amounts by planar micro-electronic manufacturing techniques.

Planar micro-electronic manufacturing techniques make it possible to obtain in said print head elements very tiny ion production channels which is in favour of high image resolution. By planar micro-electronic manufacturing techniques it is possible to group said print head elements in modules that are easy mountable and replaceable in the final print head and to have the micro circuitry for addressing their ion production and modulation functions included in said modules.

### SUMMARY OF THE INVENTION

According to the present invention a print head element 200 for an ionographic print head 313 is provided comprising:
1.a means 216 for introducing an ionisable gas or gas mixture into a channel 201,
2.a driver electrode 204,
3. a control electrode 205,
4.a dielectric body (202, 203) keeping said driver electrode 204 and control electrode 205 separate,
5. means 208 for applying an alternating voltage between said driver electrode 204 and control electrode 205, said voltage being effective for the ionization of said gas or gas mixture in said channel 201 in an ion generation region between said driver electrode 204 and control electrode 205,
6.a modulation electrode 206 being separate from said control electrode 205 by dielectric material 213,
7.means 211 for applying a direct current voltage between said modulation electrode 206 and control electrode 205 to either block ions in said channel 201 or to allow the flow out of said ions from said channel,
characterized in that:
   (i) said channel is a tubular channel 201 having at one end, at the side of the driver electrode 204, an inlet opening for receiving said ionisable gas or gas mixture,
   (ii) said driver electrode 204 is a planar electrode surrounding said tubular channel 201,
   (iii) said driver electrode 204 is embedded in dielectric material of said dielectric body 202 and 203, whereas said control electrode 205 has a border area defining part of said tubular channel 201 so as to make contact with said ionisable gas or gas mixture, and
   (iv) said modulation electrode 206 at the other end of said tubular channel 201 has an aperture 207 allowing said flow out of ions from said tubular channel 201.

Further according to the present invention an ionographic printing apparatus 292 comprises the following elements:
A) an ionographic imaging station 222 comprising a print head 313 facing an electrostatic charge receiving member 320 comprising an electrically insulating layer 214 for receiving at one side thereof a latent electrostatic charge image, said electrically insulating layer 214 being present in an electric field for attracting ions onto said side, said print head 313 comprising print head elements 200 including:
   1. a means 216 for introducing an ionisable gas or gas mixture into a channel 201 of each print head element 200,
   2. a driver electrode 204,
   3. a control electrode 205,
   4. a dielectric body (202, 203) keeping said driver electrode 204 and control electrode 205 separate,
   5.means 208 for applying an alternating voltage between said driver electrode 204 and control electrode 205, said voltage being effective for the ionization of said gas or gas mixture in said channel 201 in an ion generation region between said driver electrode 204 and control electrode 205,
   6.a modulation electrode 206 being separate from said control electrode 205 by dielectric material 213,
   7. means 211 for applying a direct current voltage between said modulation electrode 206 and control electrode 205 to either block said ions in said channel 201 or to allow the flow of said ions out from said channel,
B) a development station 314 for developing said charge image by means of toner particles so as to obtain a visible toner image,
C) a transfer zone 328 wherein said toner image can be transferred onto an intermediate toner image receiving member 317 or directly onto a final substrate 231, and
D) a cleaning station 310 for removing residual toner particles, and
E) a station 312 for removing residual electrostatic charges, and
F) a fixing station 293 for fixing said transferred toner image onto said final substrate 231, characterized in that:
   (i) said channel 201 is a tubular channel 201 having at one end, at the side of the driver electrode 204, an inlet opening for receiving said ionisable gas or gas mixture,
   (ii) said driver electrode 204 is a planar electrode surrounding said tubular channel 201,
   (iii) said driver electrode 204 is embedded in dielectric material of said dielectric body 202 and/or 203, whereas said control electrode 205 has a border area defining part of said tubular channel 201 so as to make contact with said ionisable gas or gas mixture, and
   (iv) said modulation electrode 206 at the other end of said tubular channel 201 has an aperture 207 allowing said flow out of ions from said tubular channel 201.

Further the present invention relates to a method for placing electrostatic charges by means of ions produced in an ionographic print head 313 in an image wise pattern on a dielectric substrate 214, said method including the steps of:
A) introducing an ionisable gas or gas mixture into each channel 201 of print head elements 200 part of said ionographic print head 313,
B) producing said ions in said channels 201 by an alternating voltage applied between a driver electrode 204 and a neighbouring control electrode 205 both said electrodes being separated by a dielectric body (202, 203),
C) modulating a stream of ions by either blocking or allowing said ions to leave said channels 201 using a modulation electrode 206 at the output side of said channels 201,
D) electrostatically attracting ions that are allowed to leave said channels 201 towards said dielectric substrate 214,
characterized in that:
   (i) said ionisable gas or gas mixture is introduced, at the side of the driver electrode 204, into a tubular channel 201 of each of said print head elements 200,
   (ii) an alternating voltage being effective for the ionization of said gas or gas mixture is applied between said driver electrode 204 and said control electrode 205, the driver electrode 204 surrounding tubular channel 201 and being embedded in said dielectric body 202 and 203, the control electrode 205 having a border area defining part of tubular channel 201 for contact with said ionisable gas or gas mixture, and
   (iii) said ions are accelerated out of said tubular channel 201 through an aperture 207 of its modulation electrode 206 by means of a direct current voltage between said modulation electrode 206, said control electrode 205, said driver electrode 204 and an electrode 210 backing said dielectric substrate 214.

Specific features of particular and/or preferred embodiments are set out in the dependent claims.

An advantage of the use of a print head element according to the present invention comes from the straight flow of ionisable gas from input to output of the tubular channel in said element whereby turbulence of ionisable gas is prevented. Hereby the divergence of the jet of ions from said cells towards the receptor surface is kept very low yielding sharp ion dots necessary for obtaining high resolution non-blurred images.

A further advantage comes from the embodiment of the present invention wherein very tiny print head elements are present in redundancy in the print head grouped therein in sub-modules in staggered position. Thereby it is made practically impossible to have visible white lines produced in the final toner-developed print. Single toner particles can be held by many small ion charge dots corresponding each with very small ion production channels.

### BRIEF DESCRIPTION OF THE DRAWINGS

FIG. 1 is a schematic cross-sectional view of a prior art print head element of published European Pat. Application 0 541 841 A1 (FIG. 3).

FIG. 2 is a schematic cross-sectional view of a prior art ionographic print head element of U.S. Pat. No. 4,538,163 (FIG. 7).

FIG. 3 is a schematic cross-sectional view of an ionographic print head element 200 according to the present invention.

FIG. 4a represents a bottom view, i.e. at the ion exit side, of a row of print head elements 200 according to the present invention containing said print head elements 200 arranged in staggered position. The bottom view shows the channel apertures 207 surrounded by modulation electrodes 206 having conductive stripes 252 for their electronic addressing.

FIG. 4b represents a plurality of print head elements 200 arranged linearly into a group called sub module 253.

FIG. 4c represents a plurality of sub-modules 253 arranged on a support in staggered position to form modules 254 that allow their easy mounting and replacement in the print head 313 that has a curved surface 257 at the ion exit side.

FIG. 5 is a sectional schematic side view of an ionographic imaging station 222 containing a rotatable printing drum 320 operating with a print head 313 according to the present invention in conjunction with an intermediate toner-image receiving drum 317.

FIG. 6 is a sectional schematic side view of a printing apparatus 292 according to the present invention for direct printing one colour, e.g. black, on a web-type support 231 guided by a rotatable drum 318.

FIGS. 7a and 7b represent respectively a schematic side view of an ionographic printing apparatus 292 according to the present invention for printing toner images through an offset belt 319 on a flexible substrate 231, e.g. paper web or textile, and on a rigid substrate 232, e.g. wooden panel or metal plate.

### DETAILED DESCRIPTION OF THE INVENTION

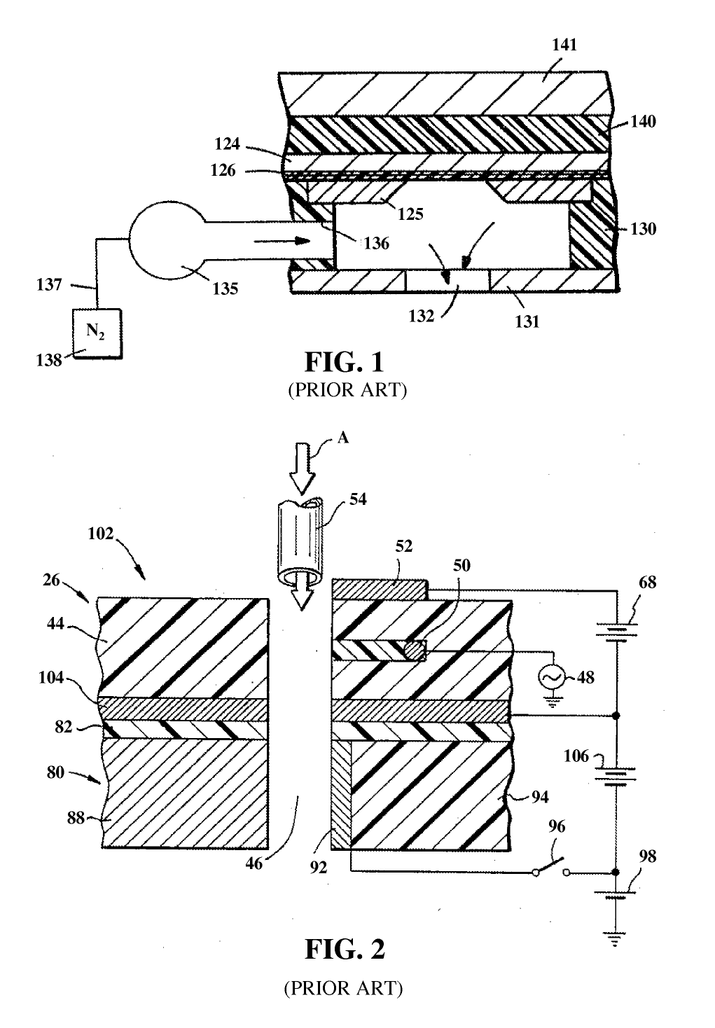

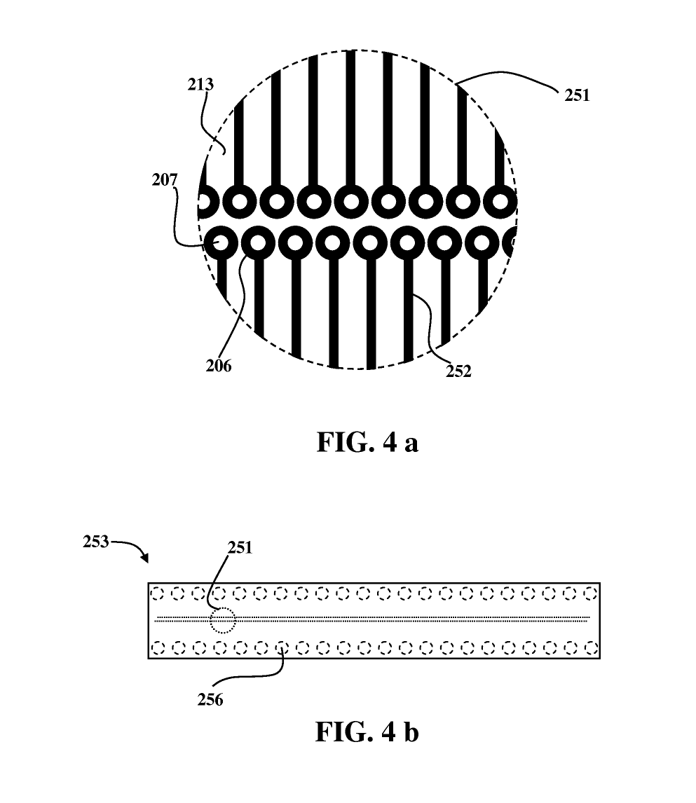

From present FIG. 1, being actually the FIG. 3 of prior art published European Pat. Application EP 0 541 841 A1 can be learned that in the illustrated print head element an ionisable gas, nitrogen or like gas at more than ambient pressure, is introduced through the insulating spacer 130 into the discharge region between the control electrode fingers 125 (second electrode) and the screen electrode 131 (third electrode) that has an opening 132. Openings or jets 136 in said insulating spacer 130 have a vector generally parallel to the control fingers 125, and said jets are connected to the plenum 135 (main conduit of a manifold), which itself through conduit 137 is connected to a source 138 supplying nitrogen or like gas under pressure. In order to produce plasma ions in the ionisable gas an alternating high frequency voltage is applied between the driver electrode 124 (first electrode) and the control electrode fingers 125.

The driver electrode 124 is shown on a conventional backing insulator 140 which in turn is connected to an aluminium backbone 141.

The gas for ionization at the discharge region flows outwardly through the opening 132 in the screen electrode 131, along with the ions. Since a positive pressure is maintained at the discharge region it is extremely unlikely that conductive toner particles could enter that area and become sucked up into the openings of the print head, called ion cartridge.

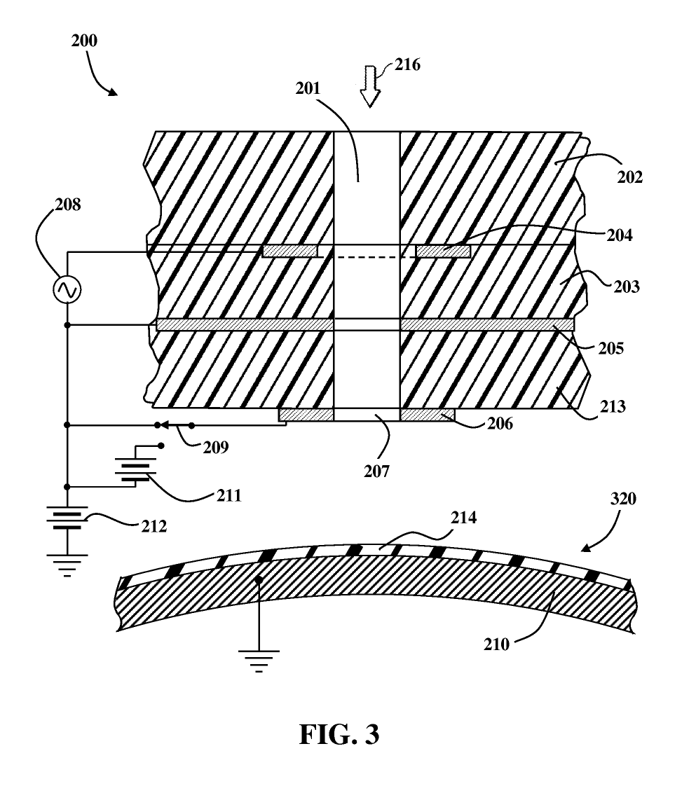

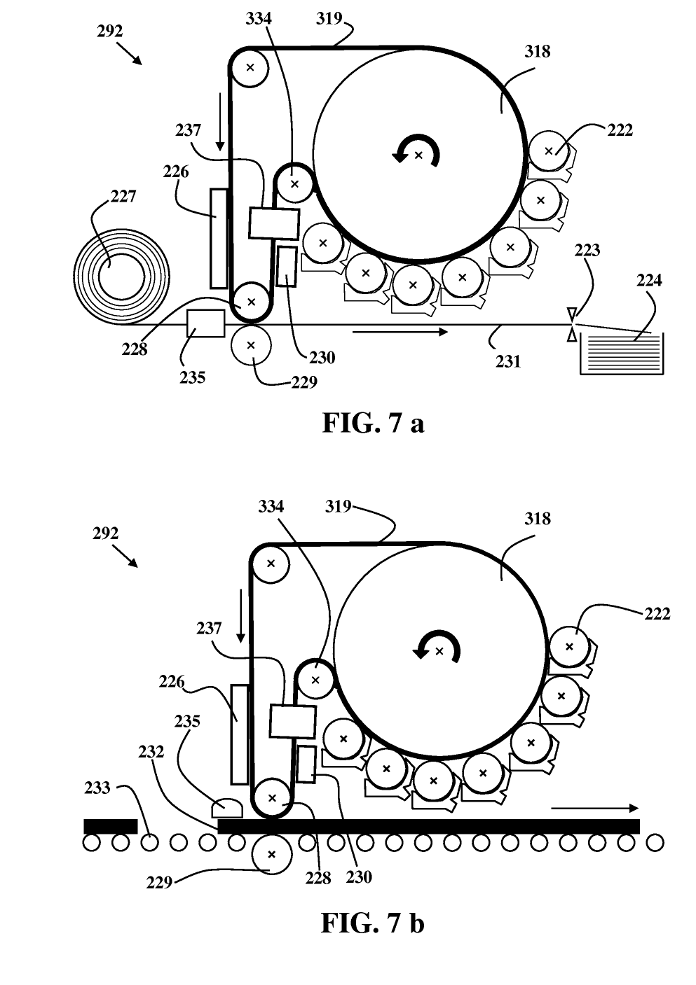

From present FIG. 2, being actually FIG. 7 of prior art U.S. Pat. No. 4,538,163 can be learned that the illustrated print head element contains a straight channel 46 which actually is an elongated channel or slit. Adjacent to the entrance of said channel 46 along the length of said channel a field electrode 52 is present and cooperates with an RF electrode 50 that has the form of a wire buried in dielectric body material 44. Between said both electrodes an RF arc discharge occurs. RF arc electrode 52 connected to earthed alternating voltage source 48 will create ions directly within a moving transport fluid A introduced into the channel 46 by some suitable means, herein represented by tube 54.

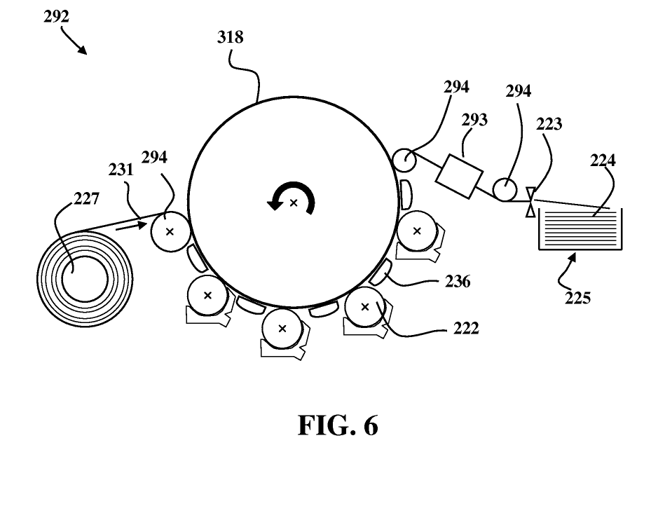

A modulation electrode 92 in the form of upright fingers in the wall of channel 46 is present on dielectric body material 94 and faces an opposing modulation plate 88. Both the modulation electrode 92 and the opposing modulation plate 88 are covered with an intermediate dielectric layer 82. Switch 96 is closed, for addressing the modulation electrode 92. A mix of positive and negative ions (see prior art FIG. 6) moves in the transport fluid stream A from the ion generation portion to the space between the modulation electrode 92 and the ion modulation plate 88 under the influence of the transverse electric field between the modulation electrode 92 and its opposing modulation plate 88 connected to the pole 90 on earth potential, whereas the electrode fingers 92 are connected over switch 96 to direct current voltage source 98. As shown, negative ions are attracted to the positively biased modulation electrode 92 and positive ions are attracted to the oppositely biased modulation plate 88. In that case the positive ions recombine with electrons from the earthed pole 90 and negative ions are attracted towards the electrically insulating substrate 86 of the recording material (see prior art FIG. 6) and that is backed by a positively biased electrode 84 being linked to the direct current voltage source 100. An intermediate electrode foil 104 prevents the RF arc discharge from adversely affecting the modulation elements as seen in the improved structure 102 of prior art FIG. 7. A reference voltage 106 biased to about 100 volts DC concentrating the electric field is connected to the foil interface electrode 104 and completely arrests erosion of the modulation elements 88 and 92.

FIG. 3 is a schematic cross-sectional view of an ionographic print head element 200 of an ionographic print head 313 according to the present invention.

Each print head element 200 of said print head 313 has a tubular and straight channel 201 in a dielectric, i.e. electrically insulating body 202, 203, 213. At one end, i.e. at the inlet opening of said tubular channel 201, a suitable gas supplying means 216 following the print head array, e.g. a manifold having a plurality of exit openings, supplies an ionisable gas or gas mixture into said tubular channel 201. Said tubular channel 201 is surrounded by a plane driver electrode 204, and (preferably plane) control electrode 205, both said electrodes being arranged substantially diametrically to the longitudinal axis of said tubular channel 201. The driver electrode 204 is embedded in dielectric material of said dielectric body 202 and/or 203, and is separated by dielectric material from said control electrode 205. The control electrode 205 forms part of said tubular channel 201, i.e. has a border area therewith, and so can make contact with said ionisable gas or gas mixture.

A modulation electrode 206, being preferably planar, is present on dielectric body 213 and surrounds the exit opening of said tubular channel 201 forming hereby a circular aperture 207.

Between said driver electrode 204 and said control electrode 205 a high frequency voltage source 208 (RF voltage source) supplies the necessary voltage pulses for an ionisation in said channel 201 in the region between driver 204 and control electrode 205 forming therein a plasma containing ions and electrons.

In closed state (as shown in the drawing) switch 209 brings all the electrodes (204, 205 and 206) at the same direct current (DC) voltage by connecting them to the positive pole of DC source 212. The negative pole of said source 212 is grounded and through the ground connected to the backing electrode 210 of the electrostatic image receptor layer 214.

As a result of said connection the positive ions in the plasma of the tubular channel 201 are attracted and accelerated towards said backing electrode 210 and deposited on the electrically insulating layer 214.

In open state switch 209 raises by means of DC voltage source 211 the voltage of modulation electrode 206 to a higher level than present at the electrodes 204 and 205. As a result thereof the positive ions of the plasma are blocked from reaching the electrically insulating layer 214. Both the control electrode 205 and modulation electrode 206 being connected to the positive pole of direct current (DC) source 211 serve as a drain for the electrons of the plasma.

According to a particular embodiment the RF voltage applied to the driver electrode 204 is 200 to 500 volt peak to peak. The frequency of the cyclic voltage change of source 208 is 100 kilohertz (kHz) to 10 Megahertz (MHz). The DC voltage of source 211 when operating with tiny tubular channels 201 can be kept fairly low, viz. between 3 to 10 volt, whereas the DC voltage of source 212 is then in the range of 200 to 500 volt.

The dielectric body 202, 203 and 213 of the print head element 200 according to the present invention can have a single material structure or is composed of a number of different layers of same or different material type with the proviso that they are all dielectric materials, e.g. silicon dioxide, aluminium oxide and silicon nitride. When uniting different inorganic layers of dielectric materials as defined above (photo) hardenable silicones may be used. The thickness of the electrodes does not have to be the same for all electrodes. The control electrode may be the thickest.

Typical suitable materials for forming the electrodes (205, 206) are metals resistive to corrosion, e.g. molybdenum, tantalum and tungsten. The driver electrode 204 being shielded from the plasma by the dielectric body material can be made of silver, copper or aluminium.

According to a preferred embodiment for ionographically printing with a print head 313 according to the present invention the aperture 207 of the modulation electrode 206 is circular and has a diameter in the range of 0.4 to 40 micrometer, more preferably 0.4 to 10 micrometer.

The ratio of aperture diameter to tubular channel length is preferably in the range of 2/1 to 1/5.

The diameter of the tubular channels 201 is not necessarily constant over their whole length with the proviso however, that the above defined aperture diameter is present. By the applied hole-etching process in the formation of said channels a funnel-like structure may be obtained therein, but the largest tubular channel diameter is preferably not more than 60 micrometer.

According to a preferred embodiment the present printing head elements 200 are used in conjunction with dry toner particles having an average weight toner size of at least 5 micrometer, more preferably in the range of 5 to 10 micrometer. The ratio of the average weight toner particle size to the diameter size of the exit aperture 207 of the tubular channel 201 is preferably in the range of 10/1 to 30/1.

According to a particular embodiment in the development of the electrostatic charge images obtained by ionographic printing electrically conductive dry toner particles are used in combination with the present ionographic print elements, such for the advantage that these particles in occasional contact with a charged electrically conductive body such as the modulation electrode are repelled by the law of induction. Said law requires that once an electrically conductive particle has taken the charge of a charged conductive body, e.g. an electrode, it obtains the charge sign thereof and becomes repelled thereby. So, a voltage modulated apertured electrode will not be covered or blocked by electrically conductive toner particles.

According to a particular embodiment conductive toner particles having a conductive substance in the bulk are used, the bulk conductivity of which is at least 10¹¹ Siemens per centimeter, an example of which can be found in U.S. Pat. No. 06467871.

According to a special embodiment conductive dry toner particles are used that have shell-core structure in which the shell composition provides an inductive charge separation in the neighbourhood of an electrostatically isolated charge pattern, i.e. here an ion charge pattern, to become attracted thereto.

Useful for the purpose of development of ionographic charge images are core-shell toner particles having a conductive shell as described in published European Patent Application 0 441 426 A1. Said toner particles carry on their surface and/or in an edge zone close to the surface fine particles of electrically conductive material consisting of fluorine-doped tin oxide. The fluorine-doped tin oxide particles have a primary particle size less than 0.2 micrometer and a specific electrical resistance of at most 50 Ohm.meter. The core of said particles is made e.g. of thermoplastic polyester and may contain magnetically attractable pigment.

In order to obtain stable and high ionization results the present print head elements are not operated with air but preferably with a noble gas or mixture thereof with nitrogen. Particularly preferred is the use of pure helium or a mixture of helium and argon gas by means of which a plasma containing positive ions and electrons is produced in an alternating field of sufficient strength.

When the major part of the ionisable gas is helium intensely charged ion beams can be formed which is particularly advantageous when operating with very tiny ionization channels. Such has to do with the fact that helium ions apart from hydrogen ions have the highest electrostatic charge to mass ratio. Argon is preferably present to some amount because argon has a fairly low ionization energy of 15.8 eV and thus operates as an ionization starter, whereas helium requires 24.6 eV being higher than that of nitrogen (14.5 eV). The restricted presence of argon is for the fact that argon in ionized state has sputtering properties which will affect the materials, e.g. thin electrodes in contact therewith.

It is general knowledge that physical sputtering is driven by momentum exchange between the ions and atoms in the surrounding material. Argon forming already relatively heavy ions is therefore detrimental to the structure of thin-film deposited active parts of an ionographic print head.

The helium-argon gas mixture applied according to the present invention contains preferably argon in no more than 20 volume percent with respect to helium. More preferably argon is present in admixture with helium in an amount between 0.5 and 10% by volume. Particularly suited is said gas mixture for use in high image resolution ionographic printing applying micro channel print head elements having very thin tubular ionization channels, whereby very fine ion beam spots at relatively low voltage gradients are produced.

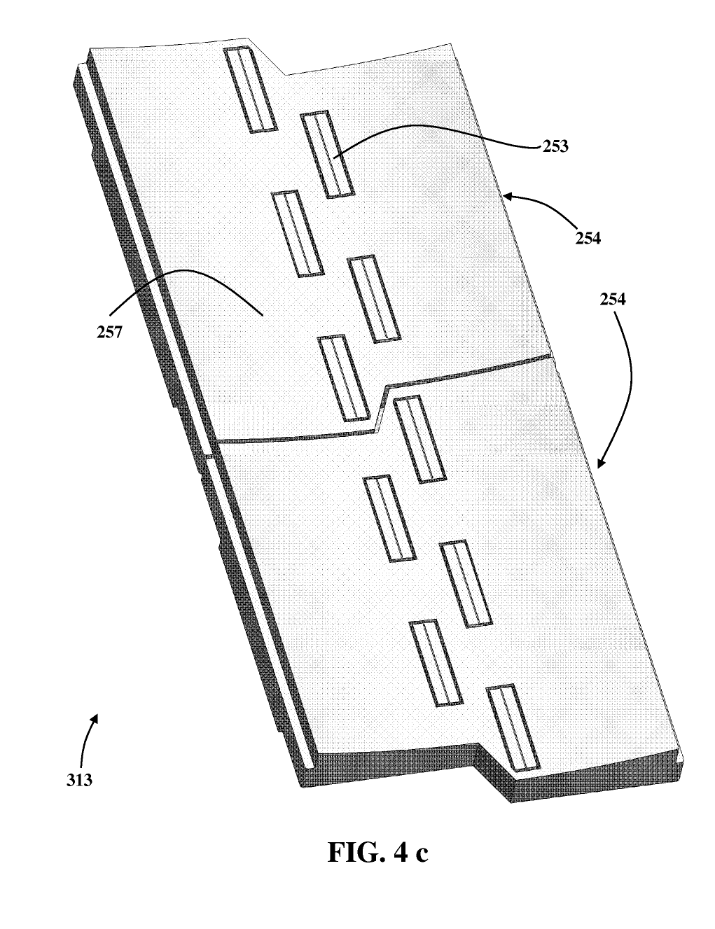

According to a preferred embodiment for fully preventing blocking of electrode apertures, e.g. with errant toner particles, the mixture of helium and argon is supplied at more than atmospheric pressure. FIG. 4a represents an enlarged bottom view 251, i.e. at the ion exit side, of a row of print head elements 200 according to the present invention containing said print head elements 200 arranged in staggered position. The bottom view shows the dielectric body 213 having channel apertures 207 surrounded by modulation electrodes 206 having conductive stripes 252 for their electronic addressing.

FIG. 4b represents a plurality of print head elements 200 arranged linearly in a group called sub module 253, the encircled part corresponds with the enlarged part of 251 of FIG. 4a. The items 256 represent electronic connection points for addressing the print head elements 200.

FIG. 4c represents a perspective view of an arrangement in a module 254 of sub-modules 253 placed in staggered position. Each module 254 forms an easily mountable and replaceable part of the print head 313 having a curved surface 257 at the ion exit side.

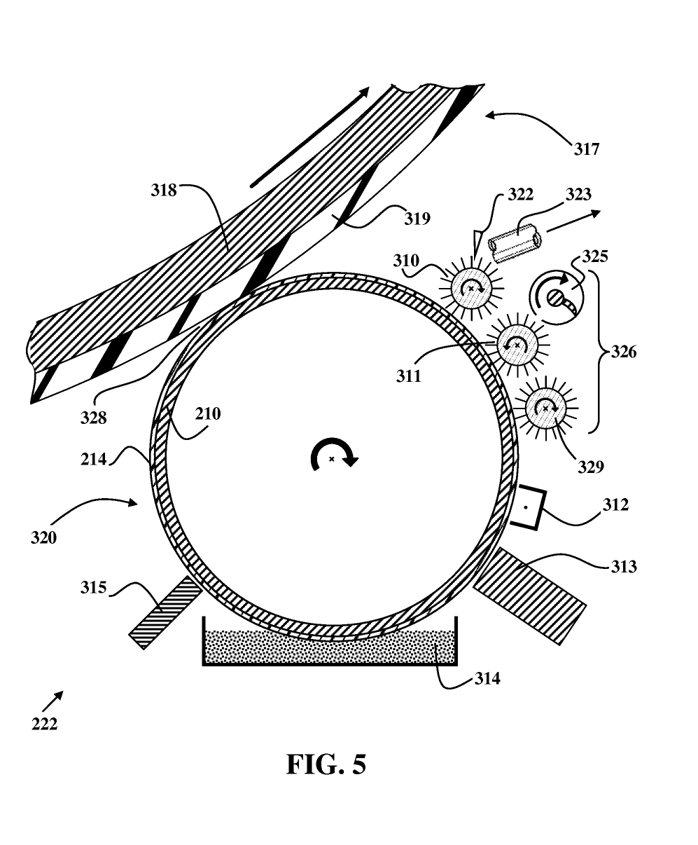

FIG. 5 is a sectional schematic side view of a printing apparatus according to the present invention for printing one colour, e.g. black, containing an electrostatic imaging station 222 in the form of a rotatable drum 320 onto which a toner image is formed for transfer onto an intermediate toner-receiving drum 317 having a resilient electrically insulating toner-receiving layer 319 coated on a cylindric support member 318.

A print head 313 according to the present invention makes part of said electrostatic imaging station 222 and faces an electrically insulating layer 214 applied on an electrically conductive cylindric support 210 of drum 320. The print head 313 projecting an ion image onto said electrically insulating layer 214 is followed in order by a toner development station 314, a cleaning station 315 for removal of superfluous toner particles i.e. for picking up e.g. by suction, non image-wise deposited toner particles, and a toner image transfer zone 328. In said zone 328 the toner image is transferred onto the supported resilient layer 319 of the rotatable intermediate toner-image receiving drum 317.

The toner image transfer zone 328 is followed by a cleaning station 310 in the form of a brush associated with a cleaning blade 322 and suction device 323 for removing toner particles left after toner image transfer. In succession therewith follows a station 326 for applying a powder material like polytetrafluorethylene having a contact angle with respect to water of at least 87° (ref. The Polymeric Encyclopedia volume 5, ed. in chief Joseph C. Salamone, CRC Press, 1996, ISBN 084932470X, p. 3192) or polyethylene having a contact angle with respect to water of at least 70° (ref. Surface characteristics of fibers and textiles, ed. Christopher M. Pastore and Paul Kiekens, CRC Press, 2000, ISBN 0824700023, p41).

Said station 326 contains a tube like vessel 325 in which a rotating helix pushes finely divided polytetrafluorethylene powder having an average grain size of 0.2 micron onto a soft brush 311, wherefrom it is sprinkled onto the electrically insulating layer 214 of drum 320. A rotating soft brush 329 smoothens the applied powder layer optionally filling up micro pores in the electrically insulating layer 214 that may be made of anodized aluminium.

According to a preferred embodiment the toner development station 314 is a fluidized bed development apparatus, e.g. of the type described in U.S. Pat. 3,380,437.

FIG. 6 is a sectional schematic side view of an ionographic printing apparatus 292 wherein the transfer of the toner image proceeds directly onto a paper web 231 as final substrate. A rotatable guiding roller 318 conveys the paper web 231 along different electrostatic toner image-forming stations 222 of the type described in FIG. 5 but each transferring a different ionographically formed toner image corresponding with a colour separation image of a multicolour original. The paper web 231 passes through the nip formed by said guiding roller 318 and the rotatable drums 320 of the toner image-forming stations 222.

Members 236 represent intermediate fixing stations. The final fixing of the toner images on the paper web 231 proceeds in station 293. The members 294 represent guiding rollers. After passing a cutting station 223 printed paper sheets 224 arrive finally in a receptor tray 225.

FIGS. 7a and 7b represent respectively a schematic side view of an ionographic printing apparatus according to the present invention capable of printing respectively toner images onto a flexible substrate 231, e.g. paper web and onto a rigid substrate 232, e.g. wooden panel or metal plate.

An offset belt 319 serving as receiving member for different toner images is rotatably driven by a rotatable guiding member 318 being a drum operating together with roller(s) 334 and contacts rotatably driven imaging stations 222 containing different coloured toners for multicolour printing.

Printing paper 231 in web form is fed from a paper supply roller 227 and is passed in the nip formed by said offset belt 319 and a backing roller 229. Said backing roller 229 is a hot fuser roller kept under pressure towards said toner-receiving offset belt 319. The belt 319 is preheated in station 226 and cooled after toner-image transfer in station 237 preceded by a cleaning station 230. The pressure applied in the nip of said backing roller 229 and the offset web 319 makes that the paper is moved in synchronism with the peripheral movement of the guiding drum 318, which is coupled to a speed controllable electric motor (not shown in the drawing).

Member 235 is a preheating station for raising the temperature of the substrate 231 or 232 to be printed improving the fixing.

Following the toner image transfer the offset belt 319 passes a cleaning station 230. The paper web 231 carrying fixed toner images is cut in a cutting station 223 whereupon printed sheets 224 are received in a tray 225.

FIG. 7b shows how a rigid panel 232, e.g. a wooden panel, receives a multicolour print. The panel 232 is conveyed on a roller bed 233 into the nip formed between the already mentioned offset belt 319 and the pressure roller 229. All the other elements shown in the drawing are the same as in FIG. 7a.

1. A print head element for an ionographic printing apparatus comprising:
1) a means for introducing an ionisable gas or gas mixture into a channel of said print head element,
2) a driver electrode,
3) a control electrode,
4) a dielectric body keeping said driver electrode and control electrode separate,
5) means for applying an alternating voltage between said driver electrode and control electrode, said voltage being effective for the ionization of said gas or gas mixture in said channel in an ion generation region between said driver electrode and control electrode,
6) a modulation electrode being separate from said control electrode by dielectric material,
7) means for applying a direct current voltage between said modulation electrode and control electrode to either block ions in said channel or to allow the flow out of said ions from said channel,
wherein:
(i) said channel is a tubular channel having at one end, at the side of the driver electrode, an inlet opening for receiving said ionisable gas or gas mixture,
(ii) said driver electrode is a planar electrode surrounding said tubular channel,
(iii) said driver electrode is embedded in dielectric material of said dielectric body, whereas said control electrode has a border area defining part of said tubular channel so as to make contact with said ionisable gas or gas mixture, and
(iv) said modulation electrode at the other end of said tubular channel has an aperture allowing said flow out of ions from said tubular channel.

2. The print head element according to claim 1, wherein said control electrode is a planar electrode surrounding said tubular channel.

3. The print head element according to claim 1, wherein said modulation electrode has a substantially circular aperture.

4. The print head element according to claim 1, wherein said means for introducing an ionisable gas or gas mixture is arranged in such a way that it can supply simultaneously said gas or gas mixture into the print head elements of an ionographic print head at substantially constant composition and at a pressure corresponding with at least atmospheric pressure.

5. The print head element according to claim 1, wherein said dielectric body of the print head element is made of at least one member selected from the group consisting of silicon dioxide, aluminium oxide, and silicon nitride.

6. The print head element according to claim 1, wherein said control electrode and said modulation electrode are made of a metal selected from the group consisting of molybdenum, tantalum and tungsten or alloys thereof

7. A-The print head element according to claim 1, wherein said means for introducing said gas or gas mixture is connected to a supply means containing for the major part by volume helium in the absence of air.

8. The print head element according to claim 7, wherein said gas mixture contains argon in no more than 20 volume percent with respect to helium.

9. The print head element according to claim 8, wherein in said gas mixture argon is present in an amount between 0.5 and 10% by volume with respect to helium.

10. The print head comprising a plurality of print head elements according to claim 1, said print head elements being arranged into sub-modules, a plurality of said sub-modules being arranged into staggered position forming a module, and a plurality of said modules forming said print head.

11. The print head according to claim 10, comprising a manifold through which said gas or gas mixture can be supplied into the tubular channels of said print head elements.

12. An ionographic printing apparatus comprising the following elements:
A) an ionographic imaging station comprising a print head 313 facing an electrostatic charge receiving member comprising an electrically insulating layer for receiving at one side thereof a latent electrostatic charge image, said electrically insulating layer being present in an electric field for attracting ions onto said side, said print head comprising print head elements having:
1) a means for introducing an ionisable gas or gas mixture into a channel of each print head element,
2) a driver electrode,
3) a control electrode,
4) a dielectric body keeping said driver electrode and control electrode separate,
5) means for applying an alternating voltage between said driver electrode and control electrode, said voltage being effective for the ionization of said gas or gas mixture in said channel in an ion generation region between said driver electrode and control electrode,
6) a modulation electrode being separate from said control electrode by dielectric material,
7) means for applying a direct current voltage between said modulation electrode and control electrode to either block said ions in said channel or to allow the flow of said ions out from said channel,
B) a development station for developing said charge image by means of toner particles so as to obtain a visible toner image,
C) a transfer zone wherein said toner image can be transferred onto an intermediate toner image receiving member or directly onto a final substrate, and
D) a cleaning station for removing residual toner particles, and
E) a station for removing residual electrostatic charges, and
F) a fixing station for fixing said transferred toner image onto said final substrate wherein:
(i) said channel is a tubular channel having at one end, at the side of the driver electrode, an inlet opening for receiving said ionisable gas or gas mixture,
(ii) said driver electrode is a planar electrode surrounding said tubular channel,
(iii) said driver electrode is embedded in dielectric material of said dielectric body, whereas said control electrode has a border area defining part of said tubular channel so as to make contact with said ionisable gas or gas mixture, and
(iv) said modulation electrode at the other end of said tubular channel 201 has an aperture allowing said flow out of ions from said tubular channel.

13. The ionographic printing apparatus according to claim 12, wherein said control electrode is a planar electrode surrounding said tubular channel.

14. The ionographic printing apparatus according to claim 12 wherein the means for introducing an ionisable gas or gas mixture into said tubular channel of said print head element comprises a manifold.

15. The ionographic printing apparatus according to claim 12, wherein said development station comprises toner particles of which the average weight toner particle size with respect to the diameter size of said aperture is in the range of 10/1 to 30/1.

16. The ionographic printing apparatus according to claim 15, wherein said development station comprises electrically conductive toner particles.

17. The ionographic printing apparatus according to claim 12, wherein said development station contains said toner particles in a fluidized bed developer tray.

18. The ionographic printing apparatus according to claim 12, wherein said apparatus comprises a station for powdering said electrostatic image receiving member with a powder of a material having a contact angle with respect to water of at least 70°, said station being arranged following said transfer zone, and being preceded by a station for removing residual toner particles after the toner image transfer.

19. The ionographic printing apparatus according to claim 12, wherein said apparatus comprises a station for picking up superfluous non image-wise deposited toner particles, said station following said development station.

20. The ionographic printing apparatus according to claim 12, wherein said apparatus comprises:
1) a rotatable guiding member for an endless belt serving as receiving member for toner images, and comprising means for rotating said guiding member and conveying said endless belt,
said apparatus comprising also a plurality of ionographic imaging stations each of which faces a different part of said endless belt which is electrically insulating at the side contacting rotatable electrostatic charge image receiving drums belonging to said ionographic imaging stations, each of said drums comprising an electrically insulating layer for receiving a latent electrostatic ion-charge image, said electrically insulating layer being present on an electrically conductive support acting as ion-attracting electrode,
2) means for rotationally driving said intermediate drum, which gives synchronous peripheral rotation to said belt and to each of said rotatable electrostatic charge image receiving drums each of which is facing an ionographic print head receiving electronic signals for modulating an ion stream to form on each of said electrostatic charge image receiving drums a different ion charge image in conformity with a colour separation image of a multi-colour original,
3) means for developing on each of said electrostatic charge image receiving drums differently coloured toner images,
4) means for transferring and controlling the superposition in registration from said belt of said differently coloured toner images onto a final substrate, and
5) means for fixing the transferred toner images by means of pressure and/or heat on said final substrate.

21. A method for placing an electrostatic charge pattern resulting from pattern-wise projection of ions onto a dielectric substrate comprising the steps of:
A) introducing into a channel of print head elements part of an ionographic print head an ionisable gas or gas mixture,
B) producing said ions in said channels by an alternating voltage applied between a driver electrode and a neighbouring control electrode, both said electrodes being separated by a dielectric body,
C) modulating a stream of ions by either blocking or allowing said ions to leave said channels using a modulation electrode at the output side of said channels,
D) electrostatically attracting ions that are allowed to leave said channels towards said dielectric substrate,
wherein:
(i) said ionisable gas or gas mixture is introduced into a tubular channel of each of 5 said print head elements,
(ii) an alternating voltage being effective for the ionization of said gas or gas mixture is applied between said driver electrode and control electrode, the driver electrode surrounding tubular channel and being embedded in said dielectric body, the control electrode having a border area defining part of 1 o tubular channel for contact with said ionisable gas or gas mixture, and
(iii) said ions are accelerated out of said tubular channel through an aperture of its modulation electrode by means of a direct current voltage between said modulation electrode and an electrode backing said dielectric substrate.
